(19) United States
(12) Patent Application Publication
(10) Pub. No.: US 2015/0055956 A1
(43) Pub. Date: Feb. 26, 2015

(54) PASSIVE OPTICAL NETWORK SYSTEM USING TIME DIVISION MULTIPLEXING

(71) Applicant: ELECTRONICS AND TELECOMMUNICATIONS RESEARCH INSTITUTE, Daejeon-si (KR)

(72) Inventors: Han Hyub LEE, Daejeon-si (KR); Sang Soo LEE, Daejeon-si (KR)

(21) Appl. No.: 14/469,069

(22) Filed: Aug. 26, 2014

(30) Foreign Application Priority Data
Aug. 26, 2013 (KR) 10-2013-0100834
Nov. 4, 2013 (KR) 10-2013-0133175
Aug. 26, 2014 (KR) 10-2014-0111221

(51) Int. Cl. H04J 14/08; H04J 14/02; H04B 10/27

(52) U.S. Cl. CPC H04J 14/08; H04B 10/27; H04J 14/02
USPC 398/79; 398/98

(57) ABSTRACT

Disclosed is a passive optical network system using a time division multiplexing scheme. According to one exemplary embodiment, the passive optical network system includes a plurality of optical network units (ONUs); an optical line terminal (OLT) to be connected to the plurality of ONUs for communication and to transmit and receive an optical signal to and from the plurality of ONUs using a time division multiplexing (TDM) scheme, wherein each of the plurality of ONUs includes a light source that generates an optical signal with a predetermined intensity even in burst-off state; and an optical filter disposed on a receiving path of an optical receiver of the OLT to filter out an optical noise signal received from an ONU in burst-off state among the plurality of ONUs.

### CROSS-REFERENCE TO RELATED APPLICATION(S)

This application claims priority from Korean Patent Application Nos. 10-2013-0100834, filed on Aug. 26, 2013, 10-2013-0133175, filed on Nov. 4, 2013, and 10-2014-011221, filed on August 26, in the Korean Intellectual Property Office, the disclosures of which are incorporated herein by references in entirety.

### BACKGROUND

1. Field

The following description relates to a passive optical network (PON) using time division multiplexing mechanism, and more particularly, to a technology capable of improving quality of upstream signals in a PON using only TDM mechanism or both TDM mechanism and wavelength division multiplexing (WDM) mechanism.

2. Description of the Related Art

A passive optical network (PON) is a subscriber network that connects a central office and a subscriber with a point-to-multipoint topology and is cost effective compared to a structure having a point-to-point topology since required central office systems and optical cables can be reduced.

A time division multiplexing-passive optical network (TDM-PON), for example, Ethernet EPON and Gigabit-Capable PON (GPON), uses one wavelength for upstream traffic and another wavelength for downstream traffic to connect a central office to subscribers, and is characterized by its use of, specifically, an optical splitter that does not require power to establish a connection between the central office and the subscribers. Thanks to such characteristics, TDM-PON has been distributed worldwide and established successfully. Particularly, GPON networks have been established across the globe, especially in Northern America and Europe. In 2010, the International Telecommunication Union Telecommunication Standardization Sector (ITU-T) completed recommendation of G.987 XG-PON standard (10G-GPON). Recently, early commercial products based on the G.987 are being released.

FIG. 1 is a diagram schematically illustrating a configuration of an existing TDM-PON system. Referring to FIG. 1, exemplary allocation of upstream/downstream transmission time for ONU1 and ONU2 is illustrated, wherein for a downstream signal from an OLT to an ONU, the transmission time is allocated to ONU1 and ONU2 in an alternate fashion, while for an upstream signal from an ONU to an OLT, a predetermined length of transmission time is first allocated to ONU1 and then a predetermined length of transmission time is allocated to ONU2. In the TDM-PON system of FIG. 1, an optical distribution network between an OLT represented as RN (“remote node”) and an ONU is an optical power splitter, which essentially requires dynamic allocation of transmission time (i.e., transmission bandwidth) between the OLT and the ONU. In the TDM-PON system, one optical source can advantageously accommodate a number of subscribers, while the transmission time to be allocated for each subscriber disadvantageously decreases with an increase in the number of operating ONUs. As examples of such a TDM-PON system, there are Ethernet-based E-PON and GEM-frame-based G-PON techniques, wherein E-PON is commercially used in Asia, especially in Japan, and G-PON is commercially used in America and Europe.

In the TDM-PON system as described above, each ONU should not output an optical signal at a transmission time that is not allocated to the ONU. Such a time period is referred to as a burst-off time. To implement the burst-off time, theoretically, operating current should not be provided to a laser diode included in a burst-mode transmitter of the ONU during a burst-off time. However, in implementation of a burst-mode transmitter of the ONU, it is impossible to completely prevent a current incoming to a light source, that is, to make 0 mA, even in burst-off state. This is because when an operating current of the laser diode (LD) used as a light source is 0 mA, the LD attempts to shift to an operating current of an arbitrary magnitude to generate an optical signal, which requires a relatively long period of time for stabilization of an output signal, and makes it difficult to output a stabilized optical signal within the allocated transmission time. To avoid such problems, in the TDM-PON system, a small amount of current may inevitably flow into the light source even in burst-off state, in which a transmission time is not allocated.

FIG. 2 is a diagram illustrating an optical output power spectrum (left) and specifications (right) of a burst mode signal according to an operating current of a laser diode used as a light source for an ONU in a TDM-PON system. Referring to the optical output power spectrum of FIG. 2, even when an operating current of the laser diode is set to 2 mA for a burst-off time, a constant optical output power is generated, which is referred to as “optical noise.” Typically, an optical power of the optical noise generated from one ONU is negligibly small, and have little effect on an OLT receiving an upstream optical signal. However, the sum of the optical noises from a plurality of ONUs may reach a considerable amount that cannot be neglected. This is because in the TDM-PON system, in addition to an optical signal from one ONU that is currently allocated a transmission time, optical noises from the other ONUs in burst-off state, that is, from all ONUs that have not yet been allocated a transmission time are also simultaneously input to an upstream signal receiver of the OLT.

FIG. 3 is a diagram schematically illustrating a plurality of optical noises and optical signals that are simultaneously input to an OLT in a TDM-PON system including a plurality of ONUs. In FIG. 3, R/S interface and SIR interface are described in the ITU-T G.987.2 that is international standard relating to TDM-PON, and the descriptions thereof will be omitted. The above international standard describes the specifications of optical noise, and more particularly, describes an intensity of an optical output power of an ONU as being 10 dB smaller than the minimum receiving sensitivity of an OLT when no signal transmission is performed.

Referring to FIG. 3, optical signals are transmitted from the plurality of ONUs to the OLT at different times, and each ONU constantly generates an optical noise and transmits it to the OTL even when it is not a transmission time allocated to the ONU. In this case, it is noticed that a signal-to-noise ratio of the signal transmitted from each ONU to the OLT is relatively large. Optical noise from the plurality of ONUs is accumulated in the upstream signal received by the OLT, and the accumulated optical noise has relatively large power, compared to an optical signal, thereby deteriorating a quality of the upstream signal that the OLT actually receives.

### SUMMARY

One purpose of the present disclosure is to provide a passive optical network system that uses a time division multiplexing (TDM) scheme and is capable of preventing deterioration of a quality of an upstream signal which may be caused by optical noise received from an ONU in burst-off state.

Another purpose of the present disclosure is to provide a TDM-PON system, such as XG-PON, in which the specification of optical noise that occurs in ONU's burst-off state is provided for minimizing deterioration in performance of an upstream signal which may be caused by the optical noise, and such optical noise can be effectively alleviated.

According to an exemplary embodiment, specification of optical noise output from an ONU in burst-off state is set to under −54 dBm, so that the deterioration in performance of an upstream signal that occurs due to the optical noise in a TDM-PON, such as XG-PON, can be minimized.

According to another exemplary embodiment, deterioration in performance of an upstream signal due to optical noise in a TDM-PON, such as an XG-PON, may be minimized by installing an optical filter that reduces optical noise power in front of an OLT, without modifying the performance of the existing ONU.

According to one exemplary embodiment of the present disclosure to achieve the above purpose, an optical line terminal (OLT) for transmitting and receiving an optical signal to and from a plurality of optical network units (ONUs) is configured to transmit and receive the optical signal to and from the plurality of ONUs using a time division multiplexing (TDM) scheme, and an optical filter is disposed on a receiving path of an optical receiver in order to filter out an optical noise signal received from an ONU in burst-off state, among the plurality of ONUs.

In one general aspect of the exemplary embodiment, the optical filter may reduce at least an intensity of the optical noise signal, thereby relatively increasing an intensity of light in a signal band. For example, the optical filter may be a bandwidth pass filter. The bandwidth pass filter may allow an optical signal in a signal band to pass therethrough while filtering out an optical noise signal that is out of the signal band.

In another aspect of the exemplary embodiment, the optical filter may be installed in front of the OLT in a passive optical network (PON) system that includes the OLT. Alternatively, the optical filter may be installed in front of the optical receiver.

According to an exemplary embodiment of the present disclosure to achieve the above purpose, a passive optical network system may include a plurality of optical network units (ONUs); an optical line terminal (OLT) to be connected to the plurality of ONUs for communication and to transmit and receive an optical signal to and from the plurality of ONUs using a time division multiplexing (TDM) scheme, wherein each of the plurality of ONUs includes a light source that generates an optical signal with a predetermined intensity even in burst-off state; and an optical filter disposed on a receiving path of an optical receiver of the OLT to filter out an optical noise signal received from an ONU in burst-off state among the plurality of ONUs.

In one general aspect of the exemplary embodiment, the optical filter may reduce at least an intensity of the optical noise signal, thereby relatively increasing an intensity of light in a signal band. For example, the optical filter may be a bandwidth pass filter. The bandwidth pass filter may allow an optical signal in a signal band to pass therethrough while filtering out an optical noise signal that is out of the signal band.

In another general aspect of the exemplary embodiment, the optical filter may be installed in front of the OLT. The optical filter may be disposed inside the OLT and in front of the optical receiver of the OLT.

In another general aspect of the exemplary embodiment, the PON system may further include an optical splitter configured to distribute a downstream optical signal from the OLT to the plurality of ONUs.

In another general aspect of the exemplary embodiment, there may be provided a plurality of OLTs that use light of different wavelengths in the PON system, and the plurality of OLTs and the plurality of ONUs may transmit and receive an optical signal therebetween using a wavelength division multiplexing (WDM) scheme as well. In this case, The PON system may further include a wavelength division multiplexer configured to multiplex downstream optical signals from the plurality of OLTs, transmit multiplexed downstream optical signals to the plurality of ONUs, demultiplex upstream optical signals from the plurality of ONUs, and transmit demultiplexed upstream optical signals to the plurality of OLTs, and the wavelength division multiplexer may be an arrayed waveguide grating (AWG).

Other features and aspects will be apparent from the following detailed description, the drawings, and the claims.

### BRIEF DESCRIPTION OF THE DRAWINGS

FIG. 1 is a diagram schematically illustrating a configuration of an existing TDM-PON system.

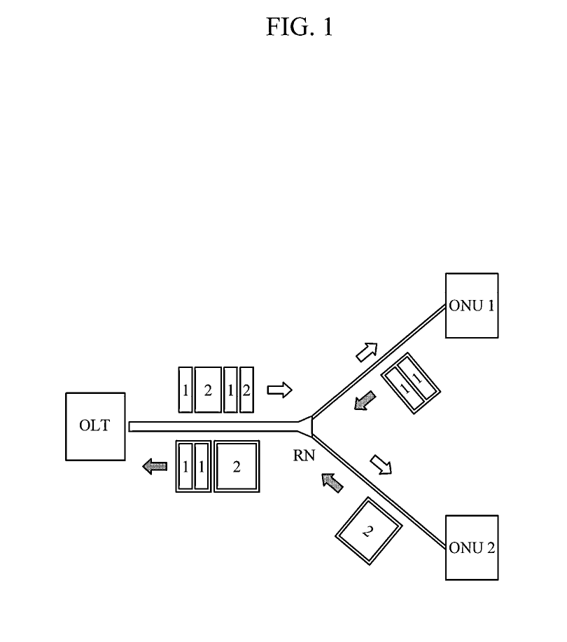

FIG. 2 is a diagram illustrating an optical output power spectrum (left) and specifications (right) of a burst mode signal according to an operating current of a laser diode used as a light source for an ONU in a TDM-PON system.

FIG. 3 is a diagram schematically illustrating a plurality of optical noises and optical signals that are simultaneously input to an OLT in a TDM-PON system including a plurality of ONUs.

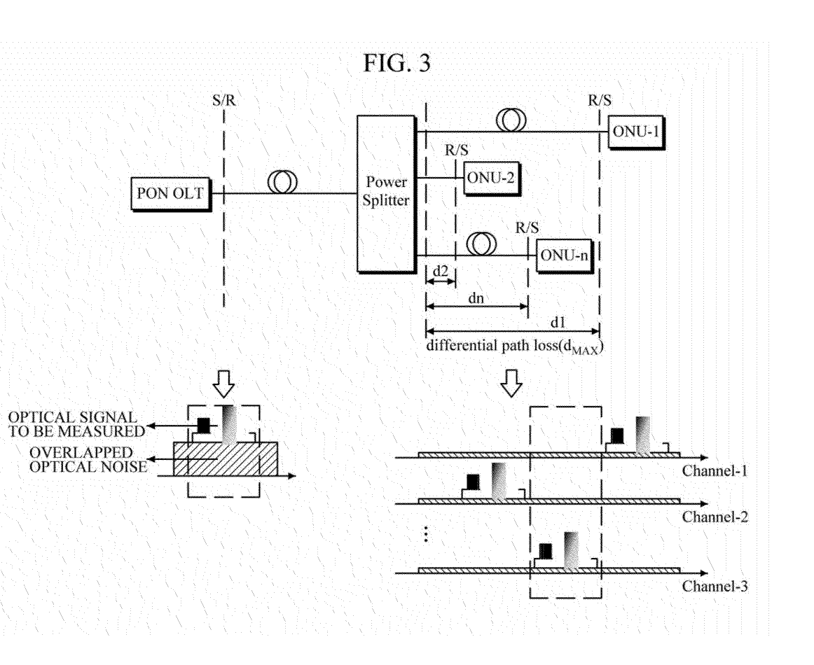

FIG. 4 is a diagram schematically illustrating a TDM system for measuring a penalty of an upstream signal.

FIG. 5 is a diagram illustrating experimental results of measuring penalties of upstream signals using physical values defined by the existing international standards when the penalties are generated due to a difference between an optical signal power and an optical noise power.

FIG. 6 is a graph showing a relationship between the number of ONUs included in a TDM-PON system and an optical noise power of an ONU required to meet a condition of crosstalk that is below −20 dB.

FIG. 7 is a diagram schematically illustrating a configuration of a TDM-PON system according to an exemplary embodiment.

FIG. 8 is a graph showing physical characteristics of an optical filter according to an exemplary embodiment.

FIG. 9 is a graph showing an optical power of an optical signal received by an OLT in the TDM-PON system of FIG. 7 to which the optical filter with the physical characteristics shown in FIG. 8 is applied.

FIG. 10 is a diagram illustrating simultaneous input of optical noise and an optical signal to an OLT in an XG-PON system.

FIG. 11 is a diagram showing crosstalk as a function with respect to the total number of ONUs included in an XG-PON system.

FIG. 12 is a graph showing a function of Poff with respect to the entire ONUs with crosstalk of −20 dB.

FIG. 13 is a diagram schematically illustrating a configuration of a TWDM-PON system.

FIG. 14 shows signal transmissions in such an AWG having a characteristic of transmission at a cyclic spacing.

FIG. 15 is a diagram illustrating an example of a broadband noise used in an experiment to measure a power of optical noise received by an optical receiver of each OLT in the TWDM-PON system of FIG. 13.

FIG. 16 is a diagram illustrating output spectrum that can be measured by an optical receiver of each OLT when the broadband noise of FIG. 15 passes through an AWG as a WM in the TWDM-PON system of FIG. 13.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Exemplary embodiments will now be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art.

Throughout the drawings and the detailed description, unless otherwise described, the same drawing reference numerals are understood to refer to the same elements, features, and structures. The relative size and depiction of these elements may be exaggerated for clarity, illustration, and convenience.

Prior to description of exemplary embodiments of the present disclosure, penalties on upstream signals that are engendered by a difference between an optical signal power and an optical noise signal power in a time division multiplexing (TDM) system that uses physical values defined by the existing international standards will be described first.

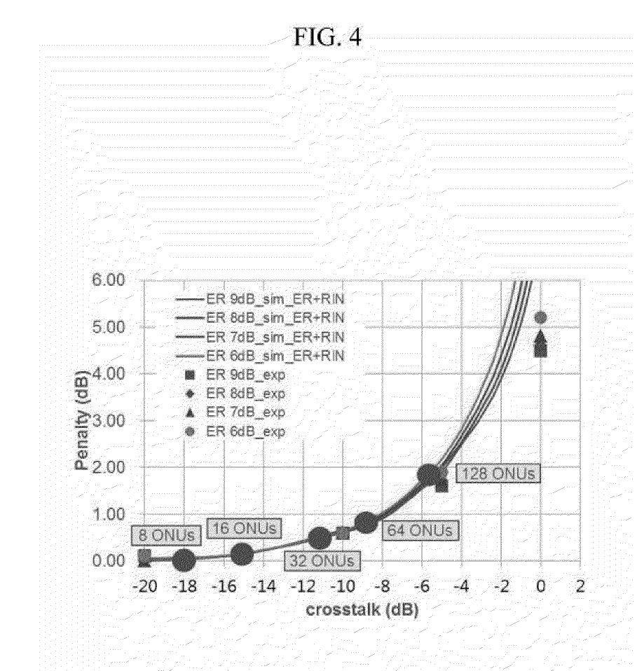

FIG. 4 is a diagram schematically illustrating a TDM system for measuring a penalty of an upstream signal. Referring to FIG. 4, an upstream signal receiver of an optical line terminal (OLT) is located on the right side, while an optical noise source of an optical network unit (ONU) is located on the left side. In an experiment, optical powers of a transmitter of the ONU and the optical noise source were individually adjusted using an optical attenuator.

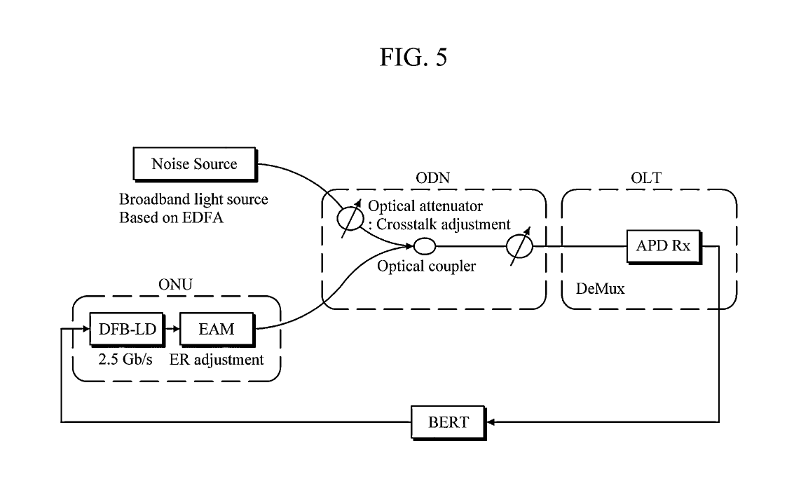

FIG. 5 is a diagram illustrating experimental results of measuring penalties of upstream signals using physical values defined by the existing international standards when the penalties are generated due to a difference between an optical signal power and an optical noise power. In FIG. 5, “Penalty” on a vertical axis indicates a degree of deterioration of the receiving performance of an upstream optical receiver of the OLT. “Crosstalk” on a horizontal axis indicates a difference between an upstream optical signal power and an optical noise power. Referring to FIG. 5, with the increase in the number of ONUs, the optical noise power increases, leading to the increase of the penalty. Referring to the graph shown in FIG. 5, in order for the penalty to be maintained to a negligible level, a value of crosstalk needs to be −20 dB, and thus the number of available ONUs is limited to 8. If there are 128 ONUs, it may cause a problem in which a penalty increases to about 2 dB.

One method for minimizing deterioration in quality of upstream signals of a TDM-PON system in accordance with the exemplary embodiments of the present disclosure is derived based on the experiment described above with reference to FIGS. 4 and 5. More specifically, according to the aforementioned experimental results and mathematical calculations, it was found that a crosstalk at an OLT was below −20 dB. Based on this finding, an optical noise power of each ONU in burst-off state was calculated.

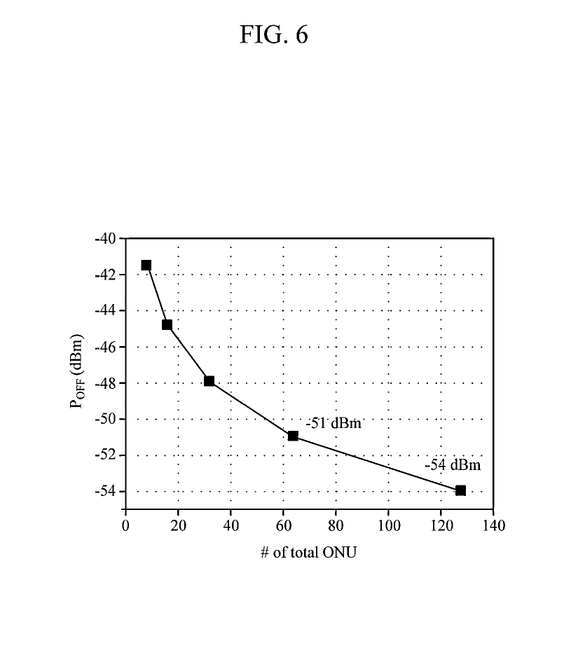

FIG. 6 is a graph showing an optical noise power of an ONU that is required to meet a condition of crosstalk below −20 dB, based on the number of ONUs included in a TDM-PON system. Generally, the TDM-PON system is designed to be connected to a total of 128 ONUs at maximum. Referring to FIG. 6, it is seen that when all 128 ONUs are connected in the system, each ONU should output an optical noise with an output power of −54 dBm or below in order to achieve a crosstalk level under −20 dB. In addition, it is found that in a case where 64 ONUs are connected, each ONU should output an optical noise with an output power of −51 dBm or below in order to achieve a crosstalk level under −20 dB.

One method to minimize deterioration of a quality of an upstream signal in the TDM-PON system according to an exemplary embodiment is reducing the entire intensity of the optical signal received by an optical receiver of the OLT by installing an optical filter at a front end of the OLT. More particularly, an optical filter that can reduce the power of optical noise while having no effect on a normal optical signal may be installed in front of the OLT. This will be described in detail below.

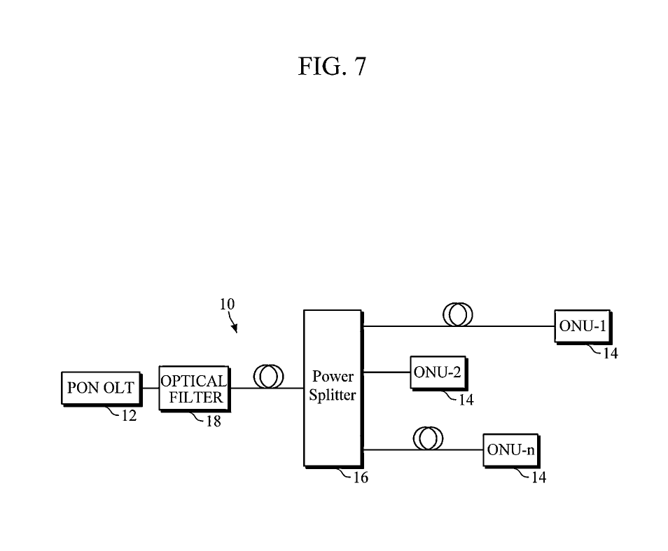

FIG. 7 is a diagram schematically illustrating a configuration of a TDM-PON system according to an exemplary embodiment. Referring to FIG. 7, a TDM-PON system 10 includes an OLT 12, a plurality of ONUs 14, an optical splitter 16, and an optical filter 18. Here, the OLT 12, the plurality of ONUs 14, and the optical splitter 16 may be elements that are commonly included in both a TDM-PON system and a TWDM-PON system that uses TDM and WDM schemes, and the functions and configurations thereof are well known to one of ordinary skill in the art. Therefore, elements related to both the well-known TDM-PON system and TWDM-PON system may be applicable to what are not described herein in detail, and the detailed description thereof will be omitted.

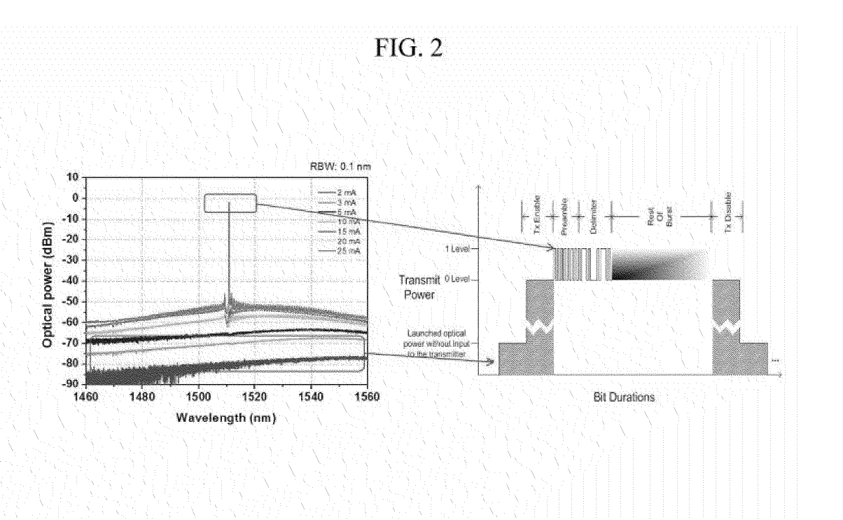

The optical filter 18 reduces at least the power of optical noise so that an optical power within a signal wavelength band becomes relatively large. The optical filter 18 reduces the intensity of an optical noise signal based on the following principle. As shown in FIG. 2, an optical noise that has been generated by an ONU in burst-off state and then transmitted to the OLT is emitted over a relatively broad bandwidth. A normal signal that has been received from an ONU, that is, an upstream signal, is transmitted to the OLT over a predetermined signal bandwidth. Thus, according to an exemplary embodiment, the optical filter 18 filters out optical noises with signal bandwidths, other than the predetermined bandwidth of the normal upstream signal, thereby reducing the entire power of the optical noise.

To this end, the optical filter 18 according to the exemplary embodiment may be a band-pass filter. In this case, the band-pass filter may be characterized to allow an optical signal in a signal band to pass therethrough while filtering out optical noise in other bands different from the signal band. Accordingly, the band-pass filter allows an optical signal in a signal band to easily pass therethrough and prevents an optical noise in a non-signal band from being received by an optical receiver of the OLT, thereby reducing the entire power of the optical noise. The optical filter has a higher performance in terms of optical noise reduction as its bandwidth is narrower, and the optical filter may be configured in consideration of a bandwidth of an upstream signal of the TDM-PON system.

In one aspect, the optical filter is used as a sole device disposed in front of the OLT. In this case, since the optical filter may affect a downstream signal, as well as the upstream signal, the optical filter may need to be designed in a manner that minimizes insertion loss relative to the downstream signal. In another aspect, the optical filter is used as a sole device, disposed in front of a receiver of an optical transceiver of the OLT or inside the receiver. In this case, since insertion loss relative to the downstream signal may not be necessarily considered in designing the optical filter, this may be viewed as an advantage for practical implementation of the optical filter.

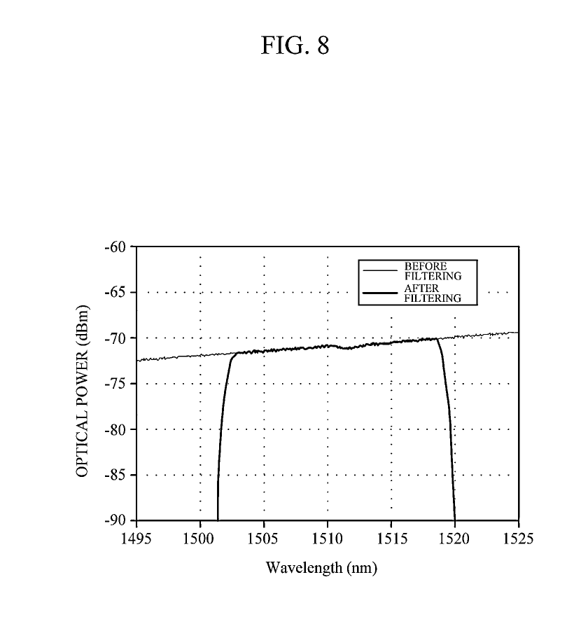

FIG. 8 is a graph showing physical characteristics of an optical filter according to an exemplary embodiment, and especially, an optical power of an optical signal before application of the optical filter that is a band-pass filter (before filtering) and an optical power after application of the optical filter (after filtering). The physical characteristics of the optical filter shown in FIG. 8 indicate a transmission characteristic of an optical signal in accordance with a pass band, and specific numbers are provided only for purpose of example. Referring to FIG. 8, in the case of application of the optical filter, it is seen that an optical signal in a pass band between about 1501 nm and about 1520 nm passes through the optical filter almost intact, without loss, while other optical signals in wavelength bands other than the pass band are filtered by the optical filter, and not able to pass through the optical filter.

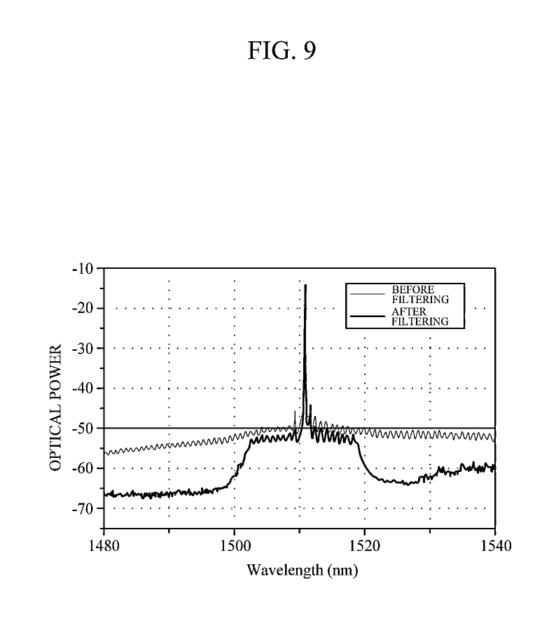

FIG. 9 is a graph showing an optical power of an optical signal received by an OLT in the TDM-PON system of FIG. 7 to which the optical filter with the physical characteristics shown in FIG. 8 is applied. Referring to FIG. 9, in a case where an optical filter with a band-pass characteristic (about 1501 to 1520 nm of signal band) is applied, it is seen that optical signals (that is, optical noises) that are received in all wave-bands, other than the signal band, are drastically reduced. As shown in FIG. 9, it is noticeable that a power of optical noise can be efficiently reduced by approximately 10 dB.

The aforementioned exemplary embodiment, that is, installation of an optical filter in front of the OLT has advantages as described below. Generally, in a TDM-PON system, an amount of current at a burst-off time may vary according to performance of a laser driver that operates an optical transmitter of an ONU, and this may make it realistically difficult to maintain constant power of optical noise. Thus, in the case of ONUs that have been already disposed in the TDM-PON system, it is necessary to replace an optical transmitter of each ONU in order to reduce the power of optical noise. However, the replacement of the optical transmitters requires substantial cost, and moreover, during the replacement, service cannot be provided. In contrast, according to the exemplary embodiments described above, it is feasible to reduce the power of optical noise that is received by the OLT, without replacing the optical transmitter of each ONU. That is, without changing the configuration of an optical transmitter of the existing ONU, it is possible to reduce the entire power of optical noise received by the OLT by simply installing an optical filter in front of the OLT.

Herein, the implementation of the exemplary embodiment in an XG-PON system, which is one of TDM-PON system, will be described in detail.

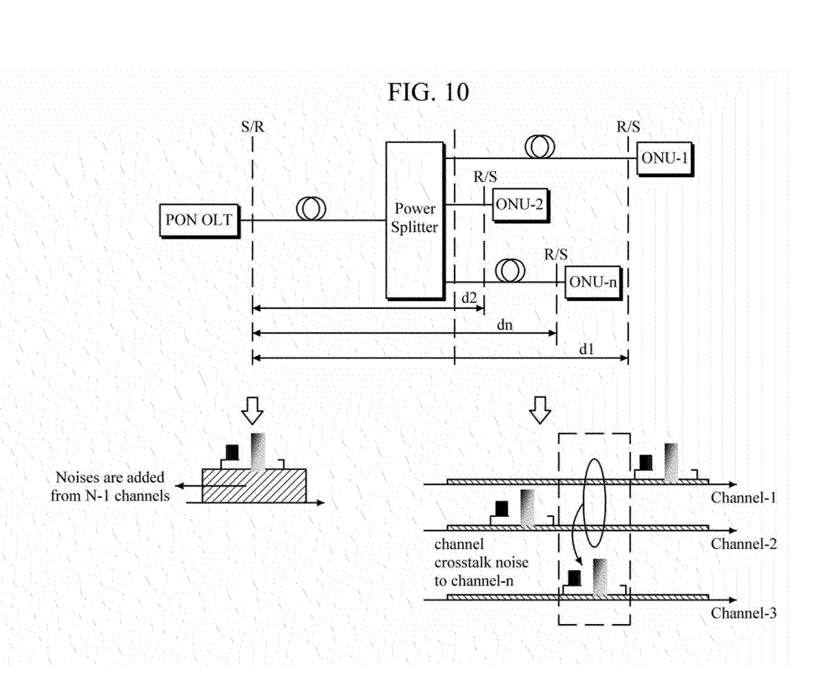

FIG. 10 is a diagram illustrating simultaneous input of optical noise and an optical signal to an OLT in an XG-PON system. In the XG-PON system as shown in FIG. 10, in worst case, an upstream signal from a particular ONU, for example, ONU-1, has a minimum power and experiences maximum differential optical path loss (dMAX) of 15 dB, while the other ONUs, i.e., ONU-2 and ONU-n, do not experience maximum differential optical path loss and may generate maximum burst-off power (POFF).

Crosstalk in the XG-PON system shown in FIG. 10 may be calculated using Equations 1 to 4 as below. (Unit of parameters is dBm or dB.)

Received signal power=Min. power of ONU Tx−dMAX−Splitter loss (1)

Total noise power=POFF+10 log(# of ONU)−1)−Splitter loss (2)

Crosstalk(noise−signal)=POFF+10 log(# of ONU-1)−Min. power of ONU Tx+dMAX (3)

POFF=Crosstalk−10 log(# of ONU-1)+Min. power of ONU Tx−dMAX (4)

Here, POFF represents a launched optical power without input to the transmitter and dMAX represents maximum differential optical path loss.

The maximum value of dMAX may be calculated by Equation 5 as below.

dMAX≦Loss budget−Splitter loss (5)

It may be referred to ITU-T G.987.2 for Poff and loss budget, where Poff is defined as “Min. Sensitivity−10 dB.” Since Min. sensitivity varies according to loss budget class of the XG-PON system, Poff also varies according to the class of XG-PON (N1:29 dB, N2:31 dB, E1:33 dB. and E2:35 dB).

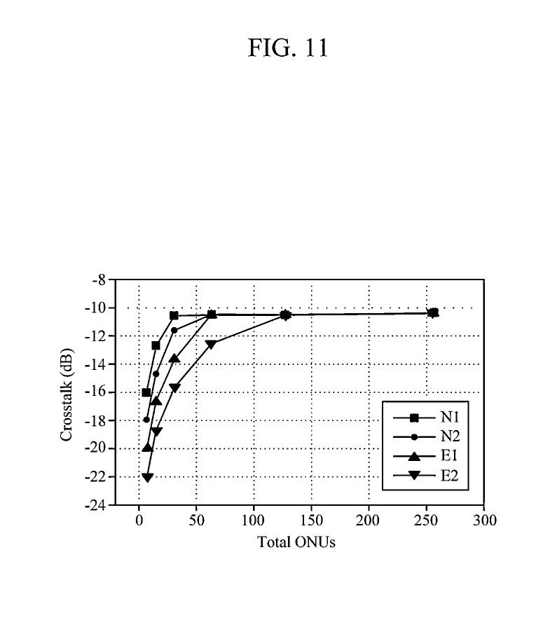

FIG. 11 is a diagram showing crosstalk as a function with respect to the total number of ONUs included in an XG-PON system. Crosstalk in FIG. 11 is stabilized at −10.4 dB, and crosstalk penalty is 0.7 dB with reference to the above description. This results from a limited dMAX condition according to Equation 5. In an experiment, the worst case system design approach was utilized, where splitter loss of a 1:2 splitter was set to 3 dB. 3.5 dB, which is often used in loss budget calculation, is a reasonable number to be used in the “worst case.” However, the minimum splitter loss may be considered as the worst case.

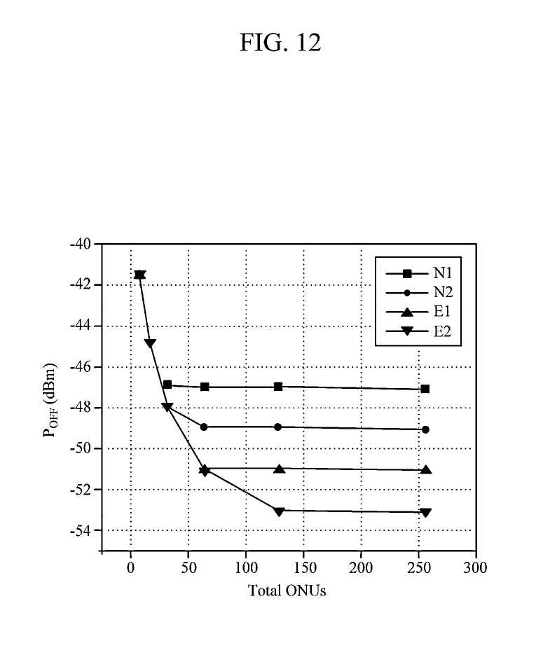

FIG. 12 is a graph showing a function of Poff with respect to the entire ONUs with crosstalk of −20 dB. FIG. 12 shows results of computation of Poff that renders −20 dB crosstalk that corresponds to 0.1 dB power penalty. If Poff is smaller than −53.1 dBm, it is possible to maintain −20 dB crosstalk relative to the worst case of E2 class where 256 ONUs are included. The calculated Poff is lower by 8.1 dB than −45 dBm, which is Poff for E2 class currently suggested in ITU-T G987.2.

Thus, to alleviate a power difference between a value suggested in the exemplary embodiment and a value currently specified in G.987.2, an optical wavelength band-pass filter, i.e., an optical band-pass filter, may be used in front of an OLT. Considering a wide ASE noise bandwidth of 100 nm, the use of an optical band-pass filter with XG-PON upstream bandwidth of 1260 nm to 1280 nm may promote the efficient reduction of ASE noise power relative to an OLT Rx. In the above experiment, ASE noise power was reduced by 8 dB by using a single channel CWDM filter.

According to this, to limit a penalty induced by channel crosstalk with respect to an upstream signal, a parameter value of launched optical power without input to a transmitter in an R/S interface may need to be redefined as −53.1 dBm for 128 ONUs or more. Here, the “parameter value of launched optical power without input to a transmitter in an R/S interface” relates to an optical noise signal generated by a light source of an ONU in burst-off state.

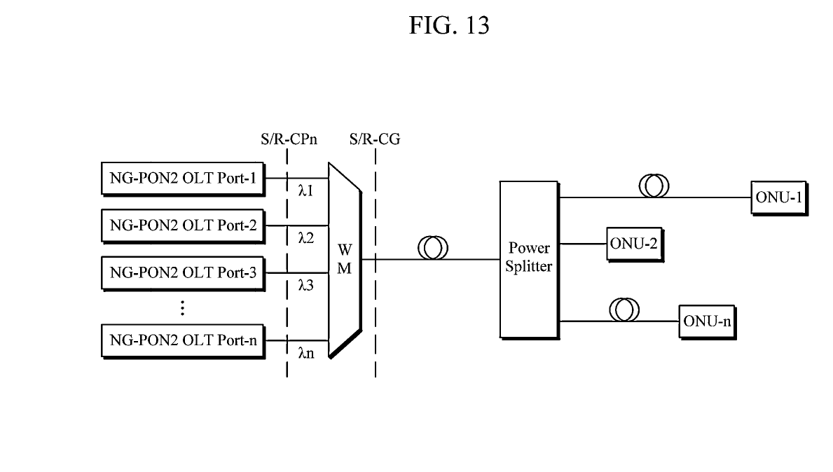

FIG. 13 is a diagram schematically illustrating a configuration of a TWDM-PON system. Referring to FIG. 13, a TWDM-PON system is a hybrid passive optical subscriber network that accommodates a central office system including n OLTs (NG-PON2 OLT in FIG. 12) that use different wavelengths. Assuming that each central office system accommodates one PON link, one optical distribution network accommodates n homogeneous or heterogeneous networks, and services are distinguished from each other by a wavelength band of a signal in use by each service. In this case, each ONU may receive a wavelength-multiplexed downstream optical signal transmitted from a plurality of TWDM-PON OLTs, and may be allowed to select a wavelength of an upstream signal corresponding to a downstream signal associated with a particular TWDM-PON OLT in order to communicate with that TWDM-PON OLT. In the TWDM-PON system, one optical distribution network accommodates n TDM-PON networks, and TDM-PON links may be distinguished from each other by different wavelengths in use.

Referring to FIG. 13, the TWDM-PON system may have a wavelength multiplexer (WM) in front of the OLT. The WM splits an upstream WDM signal by wavelength, that is, demultiplexes the upstream WDM signal. Thus, unlike the XG-PON described above, optical filtering is performed on the broadband noise by the WM, so that the intensity of the noise is substantially reduced.

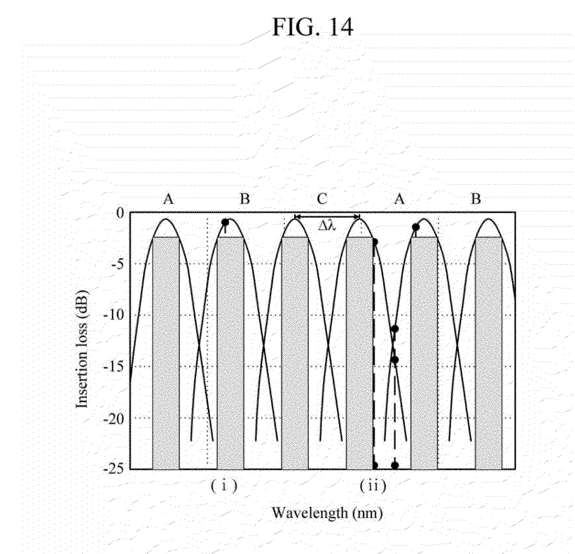

The WM may be implemented in various ways. For example, a thin-film filter or an arrayed waveguide grating (AWG) may be used to configure the WM. Research on implementation of WM using an AWG having a characteristic of transmission at a cyclic spacing has been conducted, and FIG. 14 shows signal transmissions in such an AWG having a characteristic of transmission at a cyclic spacing. Referring to FIG. 14, one output port of an AWG periodically outputs a signal of a wavelength corresponding to channel A. More specifically, signal 1, signal 5, signal 9, and the like, are output from port 1 and signal 2, signal 6, signal 10, and the like, are output from port 2.

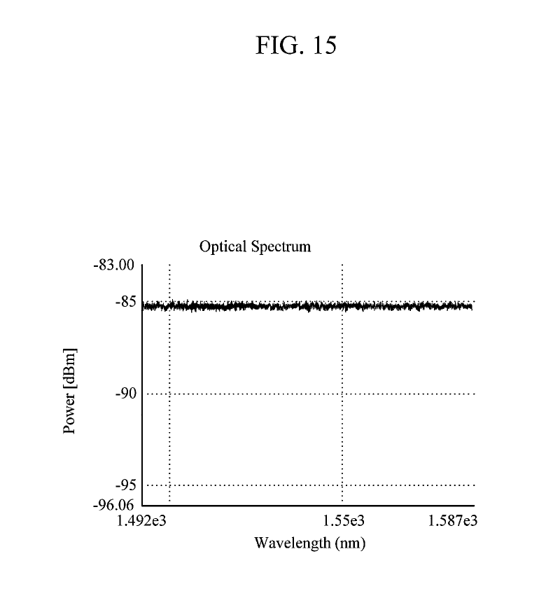

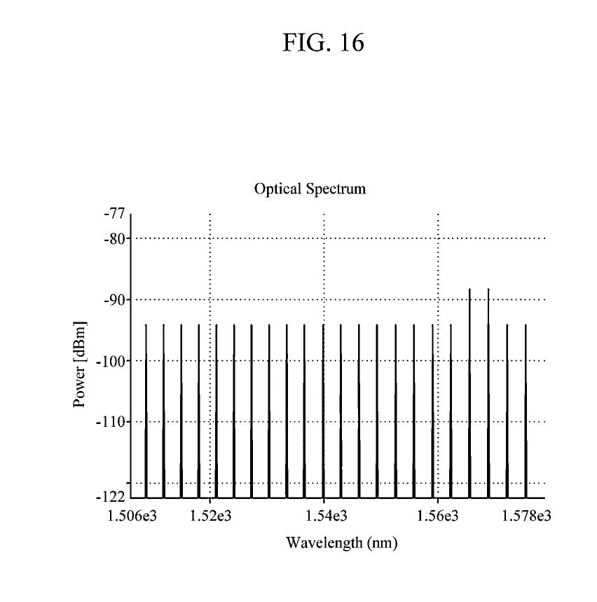

FIG. 15 is a diagram illustrating an example of a broadband noise used in an experiment to measure a power of optical noise received by an optical receiver of each OLT in the TWDM-PON system of FIG. 13. FIG. 16 is a diagram illustrating output spectrum that can be measured by an optical receiver of each OLT when the broadband noise of FIG. 15 passes through an AWG as a WM in the TWDM-PON system of FIG. 13. Referring to FIG. 16, it is noticeable that the total power of optical noise input to the optical receiver of each OLT increases. To reduce the power of such noise, an optical band-pass filter may be used as in the above exemplary embodiment. Generally, considering the wide ASE noise bandwidth of 100 nm, it is feasible to efficiently reduce power of ASE noise in a receiver of the OLT by using an optical band-pass filter with a wavelength bandwidth of about 20 nm in the TWDM-PON system. In the above experiment, ASE noise power was reduced by 8 dB by using a single channel CWDM filter.

According to the above, to limit penalty induced by channel crosstalk with respect to an upstream signal, a parameter value of launched optical power without input to a transmitter in a TWDM-PON RIS interface (refer to FIG. 13) may be suggested as shown in Table 1 below.

TABLE 1

| | 64 ONUs | 128 ONUs |
|---|---|---|
| Total Power | −42.0 dBm | −44.0 dBm |
| Power Spectral Density (PSD) | −62.0 dBm/nm | −64.0 dBm |
| Total Power One's Own Channel's | −73.0 dBm | −73.0 dBm |
| MSE (16 GHz) | | |

According to the above described exemplary embodiments, in an existing TDM-PON system, optical noise is output when an ONU is in burst-off state, so that it may be possible to prevent deterioration of an upstream signal received by an OLT. For example, according to one exemplary embodiment, specification of optical noise decreases under −54 dBm, and thus even when all optical noise is applied, a quality of the upstream signal received by the OLT is not deteriorated. In addition, according to another exemplary embodiment, an optical filter is disposed in front of the OLT in the TDM-PON system, so that the power of optical noise can be reduced even when existing ONUs are used, and thereby the quality of upstream signal can be ensured.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical line terminal (OLT) for transmitting and receiving an optical signal to and from a plurality of optical network units (ONUs), the optical line terminal configured to transmit and receive the optical signal to and from the plurality of ONUs using a time division multiplexing (TDM) scheme,
wherein an optical filter is disposed on a receiving path of an optical receiver in order to filter out an optical noise signal received from an ONU in burst-off state, among the plurality of ONUs.

2. The OLT of claim 1, wherein the optical filter reduces at least an intensity of the optical noise signal, thereby relatively increasing an intensity of light in a signal band.

3. The OLT of claim 2, wherein the optical filter is a bandwidth pass filter.

4. The OLT of claim 3, wherein the bandwidth pass filter allows an optical signal in a signal band to pass therethrough while filtering out an optical noise signal that is out of the signal band.

5. The OLT of claim 1, wherein the optical filter is installed in front of the OLT in a passive optical network (PON) system that includes the OLT.

6. The OLT of claim 1, wherein the optical filter is installed in front of the optical receiver.

7. A passive optical network system comprising:
a plurality of optical network units (ONUs);
an optical line terminal (OLT) to be connected to the plurality of ONUS for communication and to transmit and receive an optical signal to and from the plurality of ONUs using a time division multiplexing (TDM) scheme, wherein each of the plurality of ONUs includes a light source that generates an optical signal with a predetermined intensity even in burst-off state; and
an optical filter disposed on a receiving path of an optical receiver of the OLT to filter out an optical noise signal received from an ONU in burst-off state among the plurality of ONUs.

8. The PON system of claim 7, wherein the optical filter reduces at least an intensity of the optical noise signal, thereby relatively increasing an intensity of light in a signal band.

9. The PON system of claim 8, wherein the optical filter is a bandwidth pass filter.

10. The PON system of claim 9, wherein the bandwidth pass filter allows an optical signal in a signal band to pass therethrough while filtering out an optical noise signal that is out of the signal band.

11. The PON system of claim 7, wherein the optical filter is installed in front of the OLT.

12. The PON system of claim 7, wherein the optical filter is disposed inside the OLT and in front of the optical receiver of the OLT.

13. The PON system of claim 7, further comprising:
an optical splitter configured to distribute a downstream optical signal from the OLT to the plurality of ONUs.

14. The PON system of claim 7, wherein there are provided a plurality of OLTs that use light of different wavelengths, and the plurality of OLTs and the plurality of ONUs transmit and receive an optical signal therebetween using a wavelength division multiplexing (WDM) scheme as well.

15. The PON system of claim 14, further comprising:
a wavelength division multiplexer configured to multiplex downstream optical signals from the plurality of OLTs, transmit multiplexed downstream optical signals to the plurality of ONUs, demultiplex upstream optical signals from the plurality of ONUs, and transmit demultiplexed upstream optical signals to the plurality of OLTs,
wherein the wavelength division multiplexer is an arrayed waveguide grating (AWG).

16. The PON system of claim 7, wherein more than 128 ONUs are provided and each of the plurality of ONUs has −53.1 dBm as a parameter value launched optical power without input to a transmitter.
